(19) United States
(12) Patent Application Publication
(10) Pub. No.: US 2008/0107910 A1
(43) Pub. Date: May 8, 2008

(54) RESIN-COATED HOT DIP GALVANIZED STEEL SHEET SUPERIOR IN WELDABILITY AND CORROSION REISTANCE AND METHOD FOR PRODUCING THE SAME

(75) Inventors: Minoru CHIDA, Kakogawa-shi (JP); Tadashige NAKAMOTO, Kakogawa-shi (JP); Hidekazu IDO, Kobe-shi (JP); Atsushi KIHARA, Kakogawa-shi (JP); Tomio KAJITA, Kakogawa-shi (JP); Masashi IMAHORI, Kakogawa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho(Kobe Steel, Ltd.), Kobe-shi (JP)

(21) Appl. No.: 11/967,717

(22) Filed: Dec. 31, 2007

Related U.S. Application Data
(63) Continuation of application No. 10/698,519, filed on Nov. 3, 2003, now abandoned.

(30) Foreign Application Priority Data
Nov. 25, 2002 (JP) 2002-341416

(51) Int. Cl. B32B 15/04; B05D 3/02

(52) U.S. Cl. 428/450; 427/387

(57) ABSTRACT

A resin film is formed on the surface of a hot dip galvanized steel sheet by applying emulsion of a polyolefin copolymer resin molecular-associated by ion cluster to the steel sheet surface. The resin film contains, in terms of solids content, 10 to 55 mass % of silica particles, 1 to 8 mass % of a crosslinking agent, and 1 to 8 mass % of tannic acid and/or ammonium vanadate. The resin-coated hot dip galvanized steel sheet is capable of exhibiting well-balanced superior characteristics in weldability, corrosion resistance, and machinability.

### BACKGROUND OF THE INVENTION

1. Field of the Invention

The present invention relates to a hot dip galvanized steel sheet having a film formed thereon which exhibits an excellent corrosion resistance even without being subjected to chromate treatment. Particularly, the present invention is concerned with a resin-coated hot dip galvanized steel sheet capable of exhibiting superior characteristics not only in corrosion resistance, electric conductivity and machinability but also in weldability. The resin-coated hot dip galvanized steel sheet according to the present invention is employable in various uses, including construction machine parts, electric products, and automobiles. But the following description will be directed mainly to the case where the resin-coated hot dip galvanized steel sheet is applied to automobile parts as a typical example.

2. Description of the Related Art

Steel sheets presently in use for automobile parts are in many cases hot dip galvanized at their surfaces from the standpoint of ensuring corrosion resistance. In applications where the steel sheet is used in a coated state, a hot dip galvanized layer is alloyed to form a Zn—Fe alloy layer between the base steel sheet and the plating layer for the purpose of improving the coatability (coating adherence). Such an alloyed hot dip galvanized steel sheet is also in general use.

With recent diversification of the environment where hot dip galvanized steel sheets are used, in a severe environment and in long-time use, for example, in a place where the steel sheets are greatly influenced by sea salt particles such as a coastal zone or in a place where the steel sheets are influenced by acid rain such as a heavy industry zone, a mere application of the conventional hot dip galvanizing is insufficient to ensure a satisfactory corrosion resistance and the attainment of a steel sheet superior in corrosion resistance is desired. Under the circumstances, for further improving the corrosion resistance of a hot dip galvanized steel sheet, there has also been proposed a hot dip Zn-5% Al alloy coated steel sheet which is superior in corrosion resistance to the conventional hot dip galvanized steel sheets.

There sometimes is a case where even such various hot dip galvanized steel sheets are unsatisfactory in corrosion resistance (resistance to white rust), and when they are used as coating substrates, it is difficult to ensure a satisfactory adherence to a coating material used. As a remedial measure, the application of chromate treatment to the surface of a hot dip galvanized steel sheet has been conducted.

However, when chromate treatment is performed, the adherence to the resulting coating cannot be said satisfactory and there also is the problem that the harmful hexavalent chromium is contained in a large amount, although there is attained an excellent white rust suppressing effect. Particularly, in recent years, with a rise in consciousness for the environmental problem, there has been a tendency to avoiding chromate treatment, and a shift is being made to non-chromate treatment in most uses.

Under such circumstances, many studies are being made also with respect to a surface treating method not using chromate. As this type of a technique there has been proposed a method wherein the surface of a hot dip galvanized layer is coated directly with an organic film (resin film) not containing chromium (Japanese Unexamined Patent Publication No. Hei 8-67834 and Japanese Unexamined Patent Publication No. Hei 9-221595).

However, resin-coated hot dip galvanized steel sheets so far proposed are not considered satisfactory in point of adherence of the organic films to the hot dip galvanized layer. When such steel sheets are used as coating substrates, there is the problem that the organic film is apt to be peeled off at the interface with the plating layer.

Hot dip galvanized steel sheets are often used in a welded state. For example, when steel sheets are spot-welded to each other, it is important that an electric resistance (hereinafter referred to as “interlayer resistance”) of the resin film be not too high in order to ensure a satisfactory weldability. This characteristic is an important factor also when steel sheets are projection-welded to each other. Further, in the application to home electric appliances, it is necessary that an earthing performance required as product be exhibited by a high electric conductivity of the steel sheets.

Thus, it is necessary for the above hot dip galvanized steel sheets to not only exhibit corrosion resistance but also exhibit a satisfactory weldability. But the conventional resin-coated hot dip galvanized steel sheets are difficult to exhibit such characteristics. In the case of surface-treated hot dip galvanized steel sheets, no matter to what uses they may be applied, it is necessary for them to be superior in machinability. This is because they are pressed into products. The machinability, however, cannot be said satisfactory.

### SUMMARY OF THE INVENTION

The present invention has been accomplished under the above-mentioned circumstances and it is an object of the invention to provide a resin-coated hot dip galvanized steel sheet capable of exhibiting well-balanced characteristics in weldability, corrosion resistance, and machinability, as well as a method useful for producing such a resin-coated hot dip galvanized steel sheet.

The gist of the resin-coated hot dip galvanized steel sheet according to the present invention, which could achieve the above-mentioned object, resides in that a resin film formed on a surface of a hot dip galvanized steel sheet comprises a polyolefin copolymer resin molecular-associated by ion cluster to the surface of the hot dip galvanized steel sheet. The resin film further contains, in terms of solids content, 10 to less than 55 mass % of silica particles, 1 to 8 mass % of a crosslinking agent, and 1 to 8 mass % of tannic acid and/or ammonium vanadate.

An example of the polyolefin copolymer resin emulsion, which is used in producing the resin-coated hot dip galvanized steel sheet, is emulsion of a polyolefin copolymer resin molecular-associated by ion cluster prepared by ionomerizing an olefin-ethylenically unsaturated carboxylic acid copolymer resin, and by making the resulting ionomer high in molecular weight with use of a crosslinking agent. The olefin-ethylenically unsaturated carboxylic acid copolymer resin contains 1 to 40 mass % of an ethylenically unsaturated carboxylic acid and optionally contains a (meth)acrylic acid ester component. As the aforesaid olefin, at least one member selected from ethylene and styrene can be used.

It is preferable for the resin-coated hot dip galvanized steel sheet according to the present invention to satisfy at least any of the following conditions (a) to (f).

(a) The emulsion of the polyolefin copolymer resin molecular-associated by ion cluster is neutralized with an amine.

(b) The resin film is formed on the surface of the hot dip galvanized steel sheet in an amount of 0.1 to 1.5 g/m² in terms of a dry weight.

(c) The silica particles have an average particle diameter of 1 to 9 nm.

(d) The surface of the hot dip galvanized steel sheet has been subjected to skin pass rolling of 0.01% or more in terms of elongation percentage.

(e) A center line average roughness Ra at the surface of the hot dip galvanized steel sheet is in the range of 0.1 to 2.0 μm.

(f) The surface of the hot dip galvanized steel sheet is not substantially subjected to chromate treatment.

On the other hand, the gist of the method according to the present invention which could achieve the above-mentioned object resides in the steps of applying an aqueous resin coating material to a surface of a hot dip galvanized steel sheet, heating the steel sheet to dry the coating material, and thereby allowing a resin film to be formed on the surface of the hot dip galvanized steel sheet. The aqueous resin coating material comprises emulsion of a polyolefin copolymer resin molecular-associated by ion cluster, 10 to less than 55 mass % of silica particles, 1 to 8 mass % of a crosslinking agent, and 1 to 8 mass % of tannic acid and/or ammonium vanadate, in terms of solids content.

According to the present invention constructed as above it is possible to obtain a resin-coated hot dip galvanized steel sheet which exhibits well-balanced characteristics also in weldability, corrosion resistance, and machinability. Such a steel sheet is useful particularly as a stock to be used in various fields, including construction, electricity, and automobiles.

### DESCRIPTION OF THE PREFERRED EMBODIMENTS

The present inventors have made studies from the standpoint of improving the characteristics of a resin-coated hot dip galvanized steel sheet. Through the studies we have found out that by adjusting composition of the resin film appropriately there could be obtained a resin-coated hot dip galvanized steel sheet not only improved in corrosion resistance and electric conductivity but also remarkably improved in such characteristics as film adherence and machinability. Since this finding proved to have a technical significance, we have filed an application for this finding (Japanese Patent Application No. 2002-154647).

By the development of such a technique it became possible to remarkably improve the characteristics of the resin-coated hot dip galvanized steel sheet. However, also in this technique there remains a slight room for improvement. More particularly, there has been the problem that the interlayer resistance somewhat rises due to characteristics of the resin film formed on the steel sheet surface, resulting in weldability (e.g., continuous spottability in spot welding or projection-weldability) being somewhat deteriorated.

We have further made earnest studies with the intention of obtaining a resin-coated hot dip steel sheet which remedies the above-mentioned problem. As a result, we found out that by adjusting the resin film composition appropriately as above the weldability is improved to a remarkable extent while maintaining good basic characteristics. In this way we completed the present invention. The following description is now provided about conditions defined in the present invention.

In the present invention, emulsion of a polyolefin copolymer resin molecular-associated by ion cluster is used as a resin component in the aqueous resin coating material. It is preferable that the polyolefin copolymer resin emulsion be prepared by ionomerizing an olefin-ethylenically unsaturated carboxylic acid copolymer resin and making the resulting ionomer high in molecular weight with use of a crosslinking agent. The olefin-ethylenically unsaturated carboxylic acid copolymer resin contains 1 to 40 mass % of an ethylenically unsaturated carboxylic acid component and optionally contains a (meth)acrylic acid component.

The emulsion of the polyolefin copolymer resin molecular-associated by ion cluster can be obtained by going through a first step of preparing a polyolefin copolymer having carboxyl group, a second step of ionomerizing the resulting polyolefin copolymer, and a third step of making the resulting ionomer resin high in molecular weight.

Then, silica particles and a crosslinking agent are added respectively in predetermined amounts to the resulting polyolefin copolymer resin emulsion, further, tannic acid and/or ammonium vanadate are (is) also added to the emulsion, to prepare an aqueous resin coating material, then this aqueous coating material is applied to the surface of a galvanized steel sheet and subsequently the thus-coated hot dip galvanized steel sheet is heated to a predetermined temperature to dry the coating material and form a resin film, whereby there can be obtained the desired resin-coated hot dip galvanized steel sheet having a film superior in all of electric conductivity, weldability, corrosion resistance, and coatability.

In preparing the emulsion of the polyolefin copolymer resin molecular-associated by ion cluster, the first step of preparing the copolymer is as follows. First, a monomer mixture containing an olefin as a first monomer and 1 to 40 mass % of an ethylenically unsaturated carboxylic acid as a second monomer, further containing any other copolymerizable third monomer component if required, is copolymerized in an aqueous dispersion medium under the conditions of a temperature of 200° to 300° C. and a pressure of 1000 to 2000 atm. to prepare a polyolefin copolymer resin emulsion having carboxyl group.

Examples of the ethylenically unsaturated carboxylic acids are (meth)acrylic acid, maleic acid, fumaric acid, and itaconic acid, with (meth)acrylic acid being particularly preferred. As the first monomer, i.e., olefin, it is usually preferable to use an aliphatic α-olefin such as ethylene or propylene or an aromatic vinyl compound such as styrene. Thus, preferred examples of polyolefin copolymer resins employable in the present invention are ethylene-(meth)acrylic acid copolymer resin, styrene-(meth)acrylic acid copolymer resin, and ethylene-styrene-(meth)acrylic acid copolymer resin.

In the present invention, in addition to the above first and second monomers, there may be used one or more of the following compounds as a third monomer if necessary: (meth)acrylic acid esters such as methyl (meth)acrylate, ethyl (meth)acrylate, and propyl (meth)acrylate, styrene monomers such as styrene, vinyltoluene, and chloroethylene, hydroxyalkyl (meth)acrylates such as hydroxyethyl (meth)acrylate and hydroxypropyl (meth)acrylate, N-substituted (meth)acrylamides such as N-methylol (meth)acrylamide, epoxy group-containing (meth)acrylic acid esters such as glycidyl (meth)acrylate, and (meth)acrylonitrile.

In the case where the polyolefin copolymer resin in which the content of the ethylenically unsaturated carboxylic acid component becomes larger than 40 mass %, even if the emulsion of the polyolefin copolymer resin molecular-associated by ion cluster, which is obtained by subsequent emulsion ionomerizing step and high-molecularizing step, is used as a film-forming material, the resulting resin-coated hot dip galvanized steel sheet cannot exhibit a satisfactory corrosion resistance. If the content of the ethylenically unsaturated carboxylic acid component is less than 1 mass %, it is difficult to make the resulting polyolefin copolymer resin soluble or dispersible in water and thus it is impossible to obtain the emulsion used in the present invention.

As the aqueous dispersion medium there is used water or a mixture of water and a hydrophilic organic solvent. Examples of the hydrophilic organic solvent are lower fatty acid alcohols such as methanol, ethanol, and n-propanol, glycol ethers such as ethylene glycol methyl ether, glycol esters such as ethylene glycol acetate, ethers such as tetrahdrofuran and dioxane, as well as dimethyl formamide and diacetyl alcohol.

The polyolefin copolymer resin obtained in the first step is then emulsion-ionomerized. This ionomerization is usually conducted using a suitable cation under the conditions of a temperature of 80 to 300° C. and a pressure of 1 to 20 atm. As the cation, a metal ion is preferred, examples of which include lithium, potassium, magnesium, zinc, sodium, calcium, iron, and aluminum ions.

It is preferable that the emulsion of the polyolefin copolymer resin molecular-associated by ion cluster be neutralized with an amine. By such neutralization with an amine, the average particle diameter of the emulsion particles becomes smaller and the film formability is improved, so that there is exhibited water permeability suppressing effect and the corrosion resistance of film is improved. Heretofore, the neutralization in question is generally performed using ammonia, but since amines melt high in comparison with such a neutralizing agent as ammonia, the film forming speed in the application and drying of the coating material becomes mild, so that the fusing and leveling properties of emulsion particles are improved and there is formed a dense film. As the amine, isopropanolamine, N,N-diethylethanolamine, N,N-dimethylethanolamine, monoethanolamine, and N,N-butyldiethanolamine can be used.

By adding a crosslinking agent to the ionomerized resin, allowing crosslinking to take place, there can be obtained a polyolefin copolymer molecular-associated by ion cluster. As to the crosslinking agent used, no limitation is made thereto insofar as the one used can crosslink the carboxyl group contained in the polyolefin copolymer resin molecular-associated by ion cluster. For example, there may be used any of organic compounds having epoxy, isocyanate, carboxyimide, or aziridinyl group. Particularly, an epoxy group-containing crosslinking agent is preferred in point of not only corrosion resistance but also stability and crosslinking efficiency.

It is preferable that the content of the crosslinking agent in the film be in the range of 1 to 8 mass % (in terms of solids content). If the content of the crosslinking agent is less than 1 mass %, the crosslinking reaction in the polyolefin copolymer resin molecular-associated by ion cluster becomes insufficient, with the resulting film being deteriorated in corrosion resistance. If the content of the crosslinking agent exceeds 8 mass %, the aqueous coating material gels and can longer be applied to the plated steel sheet. Usually, it is preferable that the crosslinking reaction be carried out under the conditions of a temperature of 30 to 200° C. and a pressure of normal pressure to 20 atm. or so.

The coating material used in the present invention contains 10 to less than 55 mass % of silica particles in terms of solids content. The silica particles are effective in imparting excellent corrosion resistance and coatability to the resulting film and suppressing the occurrence of film scratching and blackening phenomenon at the time of machining. For allowing these effects to be exhibited, it is necessary that the content of silica particles be 10 mass % or more in terms of solids content. However, if the content of silica particles is 55 mass % or more, the silica particles will be deposited on the welding electrode tip, causing sparking, whereby the electrode tip is damaged and the service life thereof becomes extremely short.

To make the most of the above effects of the silica particles, it is preferable that the silica particles have an average particle diameter of 1 to 9 nm. The smaller the average particle diameter of silica particles, the more improved the corrosion resistance of the film. However, even if there are used silica particles of an extremely small average particle diameter, it is not that the corrosion resistance improving effect becomes outstanding in proportion thereto, but their stability in the coating material is deteriorated and the particles become easier to gel. From this standpoint it is preferable that an average particle diameter of silica particles be 1 nm or more. On the other hand, if the silica particles are very large, the film-forming property will be deteriorated, leading to a lowering of corrosion resistance, so it is preferable that the average particle diameter be not larger than 9 nm.

It is necessary that tannic acid and/or ammonium vanadata be contained in the film formed in the present invention. These components are effective in forming a non-conductive film on the surface of the hot dip galvanized steel sheet and thereby improving the corrosion resistance of the steel sheet. For allowing these effects to be exhibited effectively it is necessary that one or more of the components in question be contained in the film in an amount of 1 mass % or more. However, if the content thereof exceeds 8 mass %, the stability of the resin emulsion will be deteriorated, making it difficult to form a uniform film and thus leading to deterioration of corrosion resistance. In a high temperature/high humidity environment, the additive added in a large amount is oxidized and the appearance of the hot dip galvanized steel sheet changes in color into yellow color to a remarkable extent.

Thus, the resin-coated hot dip galvanized steel sheet according to the present invention can be produced by applying an aqueous resin coating material onto a surface of a hot dip galvanized steel sheet, then heating to a predetermined temperature to dry the coating material, and thereby allowing a resin film to be formed on the steel sheet surface. The aqueous resin coating material comprises the foregoing polyolefin copolymer resin emulsion molecular-associated by ion cluster, tannic acid and/or ammonium vanadate, predetermined amounts of silica particles and another crosslinking agent (for example, an epoxy-based crosslinking agent) in addition to the aforementioned crosslinking agent.

In the resin-coated hot dip galvanized steel sheet according to the present invention it is preferable that the amount of film deposited on the steel sheet surface be in the range of 0.1 to 1.5 g/m² in terms of a dry weight. If the film deposition quantity is smaller than 0.1 g/m², the coating material cannot be uniformly applied to the steel sheet surface and hence it becomes impossible to let desired various characteristics, including machinability, corrosion resistance, and coatability, be exhibited in a well-balanced state. On the other hand, if the film deposition quantity exceeds 1.5 g/m², both electric conductivity and interlayer resistance will be deteriorated and so will be weldability. Further, in pressing work, the amount of film peeled off increases and the thus-peeled film will be accumulated in the die used, resulting in that not only the pressing work is obstructed, but also the manufacturing cost increases.

Where required, additives for improving lubricating property and resistance to blackening phenomenon may be added to the film formed in the present invention. Of these additives, the additive (lubricant) for improving the lubricating property of the film acts effectively, through improvement of the lubricating property of the film, for preventing scratching of the film and for diminishing damage of the film during machining. As the additive, such solid lubricants as polyethylene wax, polyethylene oxide wax, polypropylene oxide wax, carnaba wax, paraffin wax, montan wax, rice wax, Teflon wax, carbon disulfide, and graphite can be used. One or more may be selected and used arbitrarily from among these lubricants. For improving the resistance to blackening of the film it is preferable that a Co-containing compound or an Ni-containing compound be contained in the film. It is necessary that the contents of these additives be set in such a range as does not impair the desired characteristics of the film. It is preferable that their contents be each up to 10 mass %.

As the hot dip galvanized steel sheet (master steel sheet) to be coated with resin in the present invention there may be used any of not only an ordinary hot dip galvanized steel sheet (GI) but also an alloyed, hot dip galvanized steel sheet (GA) obtained by alloying the steel sheet (GI) and a hot dip Zn-5% Al alloy coated steel sheet (GF). However, the present inventors have confirmed that in the case of a Zn electroplated steel sheet, even if the foregoing film is formed on the steel sheet surface, desired characteristics (especially corrosion resistance) are not exhibited.

It is also useful to apply skin pass rolling as necessary to the surface of the hot dip galvanized steel sheet used in the present invention. With such a skin pass rolling, an oxide layer on the surface of the hot dip galvanized coating is destroyed. For this reason, the reactivity between the resin film and the hot dip galvanized layer is improved, leading to a further improvement in corrosion resistance of the resin film. For allowing this effect to be exhibited it is preferable that the elongation percentage in skin pass rolling be 0.01% or more. However, as the elongation percentage becomes larger, pickup to the work roll is apt to occur, and therefore it is preferable to set the elongation percentage at 4% or less.

If the surface of the hot dip galvanized steel sheet has a certain degree of roughness, it is possible to enhance the adherence between the resin film and the hot dip galvanized layer. For allowing this effect to be exhibited it is preferable that the center line average roughness Ra at the surface of the hot dip galvanized steel sheet be set at 0.1 μm or more. However, if Ra is larger than 2.0 μm, the film becomes difficult to be formed uniformly, showing a tendency that the corrosion resistance is not improved.

It is assumed that the surface of the hot dip galvanized steel sheet used as a master steel sheet in the present invention is substantially not subjected to chromate treatment. However, if necessary, any of various chromate treatments or non-chromate treatments may be applied thereto. Further, any of various pre-treatments such as Co treatment, Ni treatment, and inhibitor treatment, may be applied to the surface of the hot dip galvanized steel sheet.

By adopting the construction described above the resin-coated hot dip galvanized steel sheet exhibits satisfactory characteristics. For the purpose of further improving corrosion resistance, adherence to a top coating material and machinability, any of various organic or inorganic films or composite organic/inorganic films may be formed (stacked) on the resin film surface.

The functions and effects of the present invention will be described below more concretely by way of working Examples of the invention, but the following Examples do not restrict the present invention, and design modifications in accordance with the above and following gists of the present invention are all included in the technical scope of the invention.

### EXAMPLES

In each of the following Examples, a hot dip galvanized steel sheet (skin pass elongation percentage: 0 to 4%, surface roughness: 0.05 to 3 μm) having been subjected to degreasing with alkali and subsequent water-washing and drying was used as a master steel sheet, then any of various films was formed on the surface thereof, and the thus-coated hot dip galvanized steel sheet was evaluated for various characteristics. In some comparative examples there also were used Zn electroplated steel sheets (EG) with varying skin pass elongation percentages. Evaluation items and testing methods in the following examples are as follows.

(1) Weldability

Using a domed electrode (tip dia.: 6 mm, 40 mmR) of 1% Cr—Cu, and using a pressure of 2156N (220 kgf) and a electric current higher by 1 KA than welding current capable of forming a nugget of 5√ at 14 cycles (60 Hz), a spot welding of 1000 spots was carried out and a percentage of good weld spots relative to all the weld spots was determined and used as weldability. Generation of expulsion and surface flash (surface spark) at all the weld spots was visually evaluated.

Weldability: percentage

Expulsion and surface flash
⊚: very good
◯: good
Δ: bad
x: very bad
   (2) Corrosion Resistance

A test piece of a flat plate edge-sealed with the back side was subjected to a salt spray test and the time until occurrence of 1% (area rate) white rust was measured, then evaluation was made on the basis of the following criterion.
⊚: 96 hours or more until occurrence of 1% white rust
◯: 48 hours or more and less than 96 hours until occurrence of 1% white rust
Δ: 24 hours or more and less than 48 hours until occurrence of 1% white rust
x: less than 24 hours until occurrence of 1% white rust
   (3) Interlayer Resistance

In accordance with JIS-C2550-9, an interlayer resistance was measured at a test voltage of 0.5V, in a measuring current range of 0 to 1 A, a total contactor area of 10 cm², and a standard test pressure of 2N/mm²±5%, then evaluation was made on the basis of the following criterion.
⊚: 0.1 to less than 1.0Ω
◯: 1.0 to less than 5.0Ω
Δ: 5.0 to less than 10.0Ω
x: 10.0Ω or more
   (4) Machinability

For evaluating deep drawability of the resultant resin-coated hot dip galvanized steel sheet, a single press test was conducted using an 80-ton crank press and the thus-pressed product was visually evaluated for scratch of a slide surface, mold scratch, and resistance to blackening phenomenon, which evaluation was made on the basis of the following criterion.
⊚: very good
◯: good
Δ: bad
x: very bad
   (5) Change of Color Tone in High Temperature/High Humidity Environment

The resultant resin-coated hot dip galvanized steel sheet was allowed to stand for 168 hours under an environment involving a temperature of 50° C. and a humidity of 98% RH and a change of color tone after the 168 hours' standing was visually checked relative to the initial color tone. Evaluation was made on the basis of the following criterion.
⊚: very good (no change of color tone)
◯: good (little change of color tone)
Δ: bad (a little change of color tone)
x: very bad (a great change of color tone)

### Example 1

A polyolefin copolymer resin emulsion containing 0.5 to 45 mass % of an ethylenically unsaturated carboxylic acid was neutralized with amine and then ionomerized with sodium hydroxide, thereafter the resulting ionomer was made high in molecular weight with an aziridinyl group-containing organic compound as a crosslinking agent to prepare emulsion of a polyolefin copolymer resin molecular-associated by ion cluster.

Further, in terms of solids content, 35 mass % of silica particles (average particle diameter: 4 to 6 nm), 5 mass % of an epoxy-based crosslinking agent (“EPICLON CR5L,” a product of Dainippon Ink & Chemicals Inc.), and 5 mass % of ammonium vanadate were added to the polyolefin copolymer emulsion molecular-associated by ion cluster to afford an aqueous resin coating material.

The aqueous resin coating material was then applied to the surface of hot dip galvanized steel sheet (skin pass elongation percentage: 1.0%, surface roughness Ra: 1.0 μm) and was then heat-dried at a sheet temperature of 100° C. to give a resin-coated hot dip galvanized steel sheet having a resin film deposited in amount of 1 g/m². Resin-coated hot dip galvanized steel sheets obtained in this way were checked for corrosion resistance, the results of which are shown in Table 1 below.

TABLE 1

| | Content (mass %) of the ethylenically | |
|---|---|---|
| No. | unsaturated carboxylic acid | Corrosion Resistance |
| 1 | 1.0 | ◯ |
| 2 | 5.0 | ⊚ |
| 3 | 10.0 | ⊚ |
| 4 | 20.0 | ⊚ |
| 5 | 40.0 | ◯ |
| 6 | 0.5 | Not dispersible in water |
| 7 | 45.0 | Δ |

### Example 2

A polyolefin copolymer resin emulsion containing 20 mass % of an ethylenically unsaturated carboxylic acid was neutralized with amine and ionomerized with sodium hydroxide, then the resulting ionomer was made high in molecular weight by adding an aziridinyl group-containing organic compound as a crosslinking agent to prepare a polyolefin copolymer emulsion molecular-associated by ion cluster.

Then, in terms of solids content, 20 to 60 mass % of silica particles (average particle diameter: 4 to 6 nm), 5 mass % of an epoxy-based crosslinking agent (“EPICLON CR5L,” a product of Dainippon Ink & Chemicals Inc.), and 5 mass % of ammonium vanadate were added to prepare an aqueous resin coating material. The aqueous resin coating material was then applied to the surface of a hot dip galvanized steel sheet (skin pass elongation percentage: 1.0%, surface roughness Ra: 1.0 μm) and was heat-dried at a sheet temperature of 100° C. to afford a resin-coated hot dip galvanized steel sheet having a film deposited in an amount of 0.5 g/m². Resin-coated hot dip galvanized steel sheets obtained in this way were checked for corrosion resistance, weldability, and expulsion and surface flash condition, the results of which are shown in Table 2 below.

TABLE 2

| | Content | | | |
|---|---|---|---|---|
| | (mass %) of the | Corrosion | Weldability | Expulsion |
| No. | silica particles | Resistance | (%) | and surface flash |
| 8 | 10 | ◯ | 100 | ⊚ |
| 9 | 20 | ⊚ | 95 | ⊚ |
| 10 | 35 | ⊚ | 90 | ⊚ |
| 11 | 50 | ⊚ | 80 | ◯ |
| 12 | 54 | ⊚ | 75 | ◯ |
| 13 | 5 | X | 100 | ⊚ |
| 14 | 9 | Δ | 100 | ⊚ |
| 15 | 56 | ⊚ | 10 | Δ |
| 16 | 65 | ⊚ | 5 | X |

### Example 3

A polyolefin copolymer resin emulsion containing 20 mass % of an ethylenically unsaturated carboxylic acid was neutralized with amine and ionomerized with sodium hydroxide, then the resulting ionomer was made high in molecular weight by the addition of an aziridinyl group-containing organic compound as a crosslinking agent to prepare a polyolefin copolymer emulsion molecular-associated by ion cluster.

Then, in terms of solids content, 35 mass % of silica particles (average particle diameter: 4 to 6 nm), 0 to 10 mass % of an epoxy-based crosslinking agent (“EPICLON CR5L,” a product of Dainippon Ink & Chemicals Inc.), and 5 mass % of ammonium vanadate, to afford an aqueous resin coating material. The aqueous resin coating material was then applied to the surface of a hot dip galvanized steel sheet (skin pass elongation percentage: 1.0%, surface roughness Ra: 1.0 μm) and was heat-dried at a sheet temperature of 100° C. to give a resin-coated hot dip galvanized steel sheet having a film deposited in an amount of 0.5 g/m². Resin-coated hot dip galvanized steel sheets obtained in this way were checked for corrosion resistance, the results of which are shown in Table 3 below.

TABLE 3

| | Content of the | |
|---|---|---|
| No. | crosslinking agent (mass %) | Corrosion Resistance |
| 17 | 1.0 | ◯ |
| 18 | 2.0 | ⊚ |
| 19 | 5.0 | ⊚ |
| 20 | 8.0 | ⊚ |
| 21 | 0 | Δ |
| 22 | 8.5 | Not applicable (the aqueous coating |
| | | material gelled)] |
| 23 | 9.0 | Not applicable (the aqueous coating |
| | | material gelled)] |

### Example 4

A polyolefin copolymer resin emulsion containing 20 mass % of an ethylenically unsaturated carboxylic acid was neutralized with amine and ionomerized with sodium hydroxide, then the resulting ionomer was made high in molecular weight by the addition of an aziridinyl group-containing organic compound as a crosslinking agent to prepare a polyolefin copolymer emulsion molecular-associated by ion cluster.

Then, in terms of solids content, 35 mass % of silica particles (average particle diameter: 4 to 6 nm), 5 mass % of an epoxy-based crosslinking agent (“EPICLON CR5L,” a product of Dainippon Ink & Chemicals Inc.), and 0 to 10 mass % of tannic acid and/or ammonium vanadate were added to afford an aqueous resin coating material. The aqueous resin coating material was then applied to the surface of a hot dip galvanized steel sheet (skin pass elongation percentage: 1.0%, surface roughness Ra: 1.0 μm) and was heat-dried at a sheet temperature of 100° C. to give a resin-coated hot dip galvanized steel sheet having a film deposited in an amount of 0.5 g/m². Resin-coated hot dip galvanized steel sheets obtained in this way were checked for corrosion resistance and change of color tone in a high temperature and high humidity environment, the results of which are shown in Table 4 below.

TABLE 4

| | | | | Change of color |
|---|---|---|---|---|
| | | | | tone in high |
| | Content of | Content | | temperature/high |
| | tannic acid | of ammonium | Corrosion | humidity |
| No. | (mass %) | vanadate (mass %) | Resistance | environment |
| 24 | 2.0 | 0 | ◯ | ⊚ |
| 25 | 5.0 | 0 | ⊚ | ⊚ |
| 26 | 8.0 | 0 | ⊚ | ◯ |
| 27 | 0 | 2.0 | ◯ | ⊚ |
| 28 | 0 | 5.0 | ⊚ | ⊚ |
| 29 | 0 | 8.0 | ⊚ | ◯ |
| 30 | 2.5 | 2.5 | ⊚ | ⊚ |
| 31 | 0 | 0 | Δ | ⊚ |
| 32 | 9.0 | 0 | Δ | Δ |
| 33 | 0 | 9.0 | Δ | ⊚ |

| | | | |
|---|---|---|---|
| 34 | 10.0 | 0 | The treating solution gelled |
| 35 | 0 | 10.0 | The treating solution precipitated |
| 36 | 5.0 | 5.0 | The treating solution gelled |

### Example 5

A polyolefin copolymer emulsion containing 20 mass % of an ethylenically unsaturated carboxylic acid was neutralized with amine or ammonia and ionomerized with sodium hydroxide, then the resulting ionomer was made high in molecular weight by the addition of an aziridinyl group-containing organic compound as a crosslinking agent to prepare a polyolefin copolymer emulsion molecular-associated by ion cluster.

Then, in terms of solids content, 35 mass % of silica particles (average particle diameter: 4 to 6 nm), 5 mass % of an epoxy-based crosslinking agent (“EPICLON CR5L,” a product of Dainippon Ink & Chemicals Inc.), and 5 mass % of ammonium vanadate were added to prepare an aqueous resin coating material. The aqueous resin coating material was then applied to the surface of a hot dip galvanized steel sheet (skin pass elongation percentage: 1.0%, surface roughness Ra: 1.0 μm) and was heat-dried at a sheet temperature of 100° C. to afford a resin-coated hot dip galvanized steel sheet having a film deposited in an amount of 0.05 to 2.5 g/m². Resin-coated hot dip galvanized steel sheets obtained in this way were checked for corrosion resistance, weldability, expulsion and surface flash, interlayer resistance, and machinability, the results of which are shown in Table 5 below.

TABLE 5

| | | Amount of | | | Expulsion | | |
|---|---|---|---|---|---|---|---|
| | Neutralizing | deposition | Corrosion | Weldability | and surface | Interlayer | |
| No. | Agent | (g/m²) | resistance | (%) | flash | Resistance | Machinability |
| 37 | Amine | 0.1 | ◯ | 100 | ⊚ | ⊚ | ◯ |
| 38 | Amine | 0.5 | ⊚ | 90 | ⊚ | ◯ | ⊚ |
| 39 | Amine | 1.0 | ⊚ | 80 | ⊚ | ◯ | ⊚ |
| 40 | Amine | 1.2 | ⊚ | 77 | ⊚ | ◯ | ⊚ |
| 41 | Amine | 1.5 | ⊚ | 75 | ◯ | ◯ | ⊚ |
| 42 | Ammonia | 0.5 | X | 90 | ⊚ | ◯ | ⊚ |
| 43 | Ammonia | 1.0 | Δ | 80 | ⊚ | ◯ | ⊚ |
| 44 | Amine | 0.05 | Δ | 100 | ⊚ | ⊚ | X |
| 45 | Amine | 1.8 | ⊚ | 60 | Δ | Δ | ◯ |
| 46 | Amine | 2.0 | ⊚ | 40 | X | X | ◯ |

### Example 6

A polyolefin copolymer resin emulsion containing 20 mass % of an ethylenically unsaturated carboxylic acid was neutralized with amine and ionomerized with sodium hydroxide, then the resulting ionomer was made high in molecular weight by the addition of an aziridinyl group-containing organic compound as a crosslinking agent to prepare a polyolefin copolymer emulsion molecular-associated by ion cluster.

Then, in terms of solids content, 35 mass % of silica particles, 5 mass % of an epoxy-based crosslinking agent (“EPICLON CR5L,” a product of Dainippon Ink & Chemicals Inc.), and 5 mass % of ammonium vanadate were added to afford an aqueous resin coating material. At this time, various types of silica particles having average particle diameters in the range of 4 to 100 nm were selected and used. The aqueous resin coating material was applied to the surface of a hot dip galvanized steel sheet (skin pass elongation percentage: 1.0%, surface roughness Ra: 1.0 μm) and was heat-dried at a sheet temperature of 100° C. to give a resin-coated hot dip galvanized steel sheet having a film deposited in an amount of 0.5 g/m². Resin-coated hot dip galvanized steel sheet obtained in this way were checked for corrosion resistance in relation to average particle diameters of silica particles, the results of which are shown in Table 6 below.

TABLE 6

| No. | Average Particle Dia. of Silica | Corrosion resistance |
|---|---|---|
| 47 | 4-6 | ⊚ |
| 48 | 10-20 | ◯ |
| 49 | 40-60 | ◯ |
| 50 | 70-100 | ◯ |

### Example 7

A polyolefin copolymer resin emulsion containing 20 mass % of an ethylenically unsaturated carboxylic acid was neutralized with amine and ionomerized with sodium hydroxide, then the resulting ionomer was made high in molecular weight by the addition of an aziridinyl group-containing organic compound as a crosslinking agent to prepare a polyolefin copolymer emulsion molecular-associated by ion cluster.

Then, in terms of solids content, 35 mass % of silica particles (average particle diameter: 4 to 100 nm), 5 mass % of an epoxy-based crosslinking agent (“EPICLON CR5L,” a product of Dainippon Ink & Chemicals Inc.), and 5 mass % of ammonium vanadate were added to prepare an aqueous resin coating material. The aqueous resin coating material was applied to the surface of a hot dip galvanized steel sheet (skin pass elongation percentage: 0 to 4.0%, surface roughness Ra: 1.0 μm) and was heat-dried at a sheet temperature of 100° C. to give a resin-coated hot dip galvanized steel sheet having a film deposited in an amount of 0.5 g/m². Resin-coated hot dip galvanized steel sheets obtained in this way were checked for corrosion resistance in relation to skin pass elongation percentage, the results of which are shown in Table 7 below.

TABLE 7

| | Master | Skin Pass Elongation | Corrosion |
|---|---|---|---|
| No. | Sheet | Percentage (%) | Resistance |
| 51 | GI | 0.01 | ⊚ |
| 52 | GI | 1.0 | ⊚ |
| 53 | GI | 2.0 | ⊚ |
| 54 | GI | 3.0 | ⊚ |
| 55 | GI | 4.0 | ◯ |
| 56 | GI | 0 | X |
| 57 | GI | 0.005 | Δ |
| 58 | EG | 0 | X |

### Example 8

A polyolefin copolymer resin emulsion containing 20 mass % of an ethylenically unsaturated carboxylic acid was neutralized with amine and ionomerized with sodium hydroxide, then the resulting ionomer was made high in molecular weight by the addition of an aziridinyl group-containing organic compound as a crosslinking agent to prepare a polyolefin copolymer emulsion molecular-associated by ion cluster.

Then, in terms of solids content, 35 mass % of silica particles (average particle diameter: 4 to 100 nm), 5 mass % of an epoxy crosslinking agent (“EPICLON CR5L,” a product of Dainippon Ink & Chemicals Inc.), and 5 mass % of ammonium vanadata were added to afford an aqueous resin coating material. The aqueous resin coating material was applied to the surface of a hot dip galvanized steel sheet (skin pass elongation percentage: 0 to 4%, surface roughness Ra: 0.05 to 3.0 μm) and was heat-dried at a sheet temperature of 100° C. to give a resin-coated hot dip galvanized steel sheet having a film deposited in an amount of 0.5 g/m². Resin-coated hot dip galvanized steel sheet obtained in this way were checked for corrosion resistance in relation to surface roughness Ra, the results of which are shown in Table 8 below.

TABLE 8

| | Master | Surface roughness | Corrosion |
|---|---|---|---|
| No. | Sheet | Ra (μm) | Resistance |
| 59 | GI | 0.1 | ⊚ |
| 60 | GI | 1.0 | ⊚ |
| 61 | GI | 1.5 | ⊚ |
| 62 | GI | 1.8 | ⊚ |
| 63 | GI | 2.0 | ◯ |
| 64 | GI | 2.5 | Δ |
| 65 | GI | 0.05 | X |
| 66 | GI | 0.08 | Δ |
| 67 | EG | 0.8 | X |

From the above tables it is seen that the resin-coated hot dip galvanized steel sheets which satisfy the conditions defined in the present invention not only have good weldability, corrosion resistance and electric conductivity but also have a moderate interlayer resistance and exhibit well-balanced characteristics also in point of coatability (coating adherence) and machinability.

What is claimed is:

1. A resin-coated hot dip galvanized steel sheet superior in weldability and corrosion resistance comprising:
a hot dip galvanized steel sheet; and
a resin film formed on a surface of said hot dip galvanized steel sheet, said resin film comprising:
a polyolefin copolymer resin molecular-associated by ion cluster;
10 to less than 55 mass % of silica particles in terms of solids content;
1 to 8 mass % of a crosslinking agent in terms of solids content; and
1 to 8 mass % of at least one of tannic acid and ammonium vanadate in terms of solids content.

2. The resin-coated hot dip galvanized steel sheet according to claim 1, wherein said polyolefin copolymer resin molecular-associated by ion cluster is prepared by ionomerizing an olefin-ethylenically unsaturated carboxylic acid copolymer resin which contains 1 to 40 mass % of an ethylenically unsaturated carboxylic acid and by making the resulting ionomer high in molecular weight with use of a crosslinking agent.

3. The resin-coated hot dip galvanized steel sheet according to claim 2, wherein said olefin is at least one member selected from ethylene and styrene.

4. The resin-coated hot dip galvanized steel sheet according to claim 1, wherein said resin film is formed on the steel sheet surface in an amount of 0.1 to 1.5 g/m² in terms of a dry weight.

5. The resin-coated hot dip galvanized steel sheet according to claim 1, wherein said silica particles have an average particle diameter of 1 to 9 nm.

6. The resin-coated hot dip galvanized steel sheet according to claim 1, wherein the surface of said hot dip galvanized steel sheet is subjected to skin pass rolling of 0.01% or more in terms of elongation percentage.

7. The resin-coated hot dip galvanized steel sheet according to claim 1, wherein a center line average roughness Ra at the surface of said hot dip galvanized steel sheet is in the range of 0.1 to 2.0 μm.

8. The resin-coated hot dip galvanized steel sheet according to claim 1, wherein the surface of said hot dip galvanized steel sheet is substantially not subjected to chromate treatment.

9. A method for producing a resin-coated hot dip galvanized steel sheet superior in weldability and corrosion resistance, said method comprising:
applying an aqueous resin coating material to a surface of a hot dip galvanized steel sheet;
heating said hot dip galvanized steel sheet to dry said aqueous resin coating material; and
allowing a resin film to be formed on the surface of the hot dip galvanized steel sheet,
wherein said aqueous resin coating material comprises emulsion of a polyolefin copolymer resin molecular-associated by ion cluster, 10 to less than 55 mass % of silica particles in terms of solids content, 1 to 8 mass % of a crosslinking agent in terms of solids content, and 1 to 8 mass % of at least one of tannic acid and ammonium vanadate in terms of solids content.

10. The resin-coated hot dip galvanized steel sheet according to claim 9, wherein said polyolefin copolymer resin emulsion molecular-associated by ion cluster is neutralized with an amine.
